(19) United States
(12) Patent Application Publication
(10) Pub. No.: US 2011/0282088 A1
(43) Pub. Date: Nov. 17, 2011

(54) PROCESS FOR PREPARING BIS- AND TRIS(SILYLORGANO)AMINES

(75) Inventors: Michael Stepp, Ueberackern (AT); Markus Jandke, Burgkirchen (DE)

(73) Assignee: WACKER CHEMIE AG, Muenchen (DE)

(21) Appl. No.: 13/142,622

(22) PCT Filed: Jan. 19, 2010
(86) PCT No.: PCT/EP2010/050576

§ 371 Date: Jun. 29, 2011

(30) Foreign Application Priority Data
Jan. 30, 2009 (DE) 10 2009 000 500.5

(51) Int. Cl. C07F 7/18

(52) U.S. Cl. 556/413

(57) ABSTRACT

The invention provides a process for preparing silylorganoamines of the general formula (1) R′₃₋ₙR¹ₙSi—R²—NR³—R⁴—SiR″₃₋ₘR⁵ₘ (1) by reacting (aminoorganyl)silanes of the general formula (2), H—NR³—R⁴—SiR″₃₋ₘR⁵ₘ (2) with (haloorganyl)silanes of the general formula (3) R′₃₋ₙR¹ₙSi—R²—X (3), where R′, R″, R¹, R², R³, R⁴, R⁵, X, m and n are each defined as per claim 1, said reaction comprising the following steps: a) reacting the (haloorganyl)silane of the general formula (3) and the (aminoorganyl)silane of the general formula (2) at a temperature of 0 to 250° C. to form, as well as the silylorganoamine of the general formula (1), the ammonium halide of the (aminoorganyl)silane of the general formula (2) as a by-product, b) adding a base (B), which results in complete or partial ester interchange, in which the (aminoorganyl)silane of the general formula (2) is released again and forms the halide of the base (B), the halide of the base (B) being liquid at temperatures of at most 200° C., and c) removing the liquid halide formed from the base (B).

The invention relates to a process for preparing bis- and tris(silylorgano)amines by reacting (aminoorganyl) silanes with (haloorganyl)silanes.

Various processes for preparing bis- and tris(silylorgano)amines are known from the prior art.

U.S. Pat. No. 6,242,627 B1 describes the hydrogenation of cyanoorganosilanes over cobalt sponges. This forms mainly aminoalkylsilanes. Bissilylalkylamines also occur as by-products. The use of highly flammable hydrogen under pressure requires a high level of safety precautions.

The same applies to the following processes:

In U.S. Pat. No. 6,417,381 B1 the hydrogenation of cyanoorgano-silanes over transition metal catalysts is utilized for preparing preferably bis(silylorganyl)silanes.
U.S. Pat. No. 2,930,809 describes the hydrogenation of cyanoorganosilanes over transition metal catalysts in the presence of ammonia, forming, inter alia, bis(silylorganyl) silanes.
EP 167887 B1 describes the targeted preparation of bissilylalkylamines from cyanoorganosilane and aminoalkylsilane by reaction with hydrogen in the presence of transition metal catalysts.

EP 531948 B1 describes the reaction of aminoalkyl-silanes over a palladium oxide catalyst to give symmetrical bis- and trissilylalkylamines. Drastic conditions (200° C., 6 h) are necessary and mixtures of mono-, bis- and tris-substitution products are obtained in each case.

EP 709391 B1 describes the hydrosilylation of bisallylamine by means of trialkoxysilane to give bissylylorganylamine. Disadvantages here are the use of expensive hydrosilylation catalysts and also the use of sometimes highly toxic starting materials, which requires demanding safety precautions.

EP 849271 B1 describes the preparation of primary aminoorganylsilanes from the corresponding chloroorganylsilanes by reaction with ammonia, giving the di- and tri-substitution products as by-products. The reaction requires the use of autoclaves and drastic reaction conditions. In addition the target products are always obtained in admixture with mono-, di- and tri-substitution products and silylorganyl-substituted amines having different silyl radicals in one molecule cannot be obtained in a targeted manner in this way. Another disadvantage of this process is the fact that ammonium halide is formed in quantitative amounts as by-product and has to be separated off as solid. Removal of such large amounts of solid is time-consuming and therefore costly and also requires production plants which have appropriate apparatuses, e.g. high-performance and therefore expensive centrifuges. However, this is not the case for many plants, in particular most multipurpose plants as are typically used for preparing fine chemicals.

Here, for example, U.S. Pat. No. 6,452,033 A describes the preparation of aminoethylaminoorganyltriorganylsilanes by reacting the corresponding chlorofunctional organo-silanes with ethylenediamine, with the above-mentioned phase separation being used to separate off the hydro-chlorides in various ways.

However, this process has the disadvantage that it is restricted to silanes which have an ethylenediamine unit.

The only advantage of this process is the ready availability of chloroorganylsilanes which can be obtained, for example, by photochlorination of alkylsilanes or hydrosilylation of appropriately halogen-substituted olefins by means of Si—H-containing compounds and are used, for example, as intermediates for the synthesis of many organofunctional silanes.

It was an object of the invention to develop a process which no longer has the disadvantages of the prior art.

The invention provides a process for preparing silylorganoamines of the general formula (1)

R′₃₋ₙR¹ₙSi—R²—NR³—R⁴—SiR″₃₋ₘR⁵ₘ (1)

by reacting (aminoorganyl)silanes of the general formula (2),

H—NR³—R⁴—SiR″₃₋ₘR⁵ₘ (2)

with (haloorganyl)silanes of the general formula (3)

R′₃₋ₙR¹ₙSi—R²—X (3),

where
R′, R″ are each an alkoxy radical having 1-10 carbon atoms,
R¹, R⁵ are each a hydrocarbon radical having 1-10 carbon atoms,
R² is a divalent hydrocarbon radical which has 1-10 carbon atoms and in which the hydrocarbon chain can be interrupted by carbonyl groups, carboxyl groups, oxygen atoms or sulfur atoms,
R⁴ is a divalent hydrocarbon radical which has 1-10 carbon atoms and in which the hydrocarbon chain can be interrupted by carbonyl groups, carboxyl groups, oxygen atoms, sulfur atoms, NH or NR⁸ groups, where R⁸ has the same meanings as R¹, R⁵,
R³ is hydrogen, a hydrocarbon radical having 1-10 carbon atoms or a radical of the general formula R″′₃₋ₒR⁶ₒSi—R⁷—, where
R⁶ has the same meanings as R¹ and R⁵,
R⁷ has the same meanings as R² and R⁴, and
R′″ has the same meanings as R′ and R″,
m, n, o are each, independently of one another, 0, 1, 2 or 3, and
X is chlorine, bromine or iodine,
   wherein the reaction comprises the following steps:
a) reaction of the (haloorganyl)silane of the general formula (3) and the (aminoorganyl)silane of the general formula (2) at a temperature of from 0 to 250° C., forming not only the silylorganoamine of the general formula (1) but also the ammonium halide of the (aminoorganyl)silane of the general formula (2) as by-product,
b) addition of a base (B), resulting in a complete or partial salt rearrangement in which the (aminoorganyl)silane of the general formula (2) is liberated again and the halide of the base (B) is formed, where the halide of the base (B) is liquid at temperatures of not more than 200° C., and
c) removal of the resulting liquid halide of the base (B).

The ammonium halide of the (aminoorganyl)silane of the general formula (2) is typically obtained as an insoluble solid which redissolves in step b) after addition of the base (B) and a separate liquid phase containing essentially the halide of the base (B) is formed and is then separated off in step c).

Based on (haloorganyl)silane of the general formula (3), the (aminoorganyl)silane of the general formula (2) is preferably used in excess, i.e. in molar ratios of from 1.1:1 to 100:1, preferably from 1.5:1 to 50:1, particularly preferably from 2:1 to 20:1, in particular from 3:1 to 10:1. Based on silane of the general formula (3), the base (B) is preferably used in molar ratios of from 0.5:1 to 10:1, preferably from 0.7:1 to 5:1, particularly preferably from 0.8:1 to 2:1, in particular from 0.9:1 to 1.0:1.

The hydrocarbon radicals R¹, R², R³, R⁴, R⁵, R⁶, R⁷ can be saturated or unsaturated, branched or unbranched, substituted or unsubstituted.

The hydrocarbon radicals R¹, R³, R⁵, R⁶ can be alkyl radicals such as the methyl, ethyl, n-propyl, isopropyl, 1-n-butyl, 2-n-butyl, isobutyl, tert-butyl, n-pentyl, isopentyl, neopentyl, tert-pentyl radicals; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl radicals and methylcyclohexyl radicals; alkenyl radicals, such as the vinyl, 1-propenyl, 2-propenyl and 10-undecenyl radicals; aryl radicals, such as the phenyl, naphthyl, anthryl and phenanthryl radicals; alkaryl radicals, such as o-, m-, p-tolyl radicals; xylyl radicals and ethylphenyl radicals; and aralkyl radicals, such as the benzyl radical, the alpha- and beta-phenylethyl radicals; and also combinations thereof linked by heteroatoms such as N, O, S, P. The hydrocarbon radicals R¹, R³, R⁵, R⁶, preferably have 1-6, in particular 1-3, carbon atoms. Preference is given to R¹, R⁵, R⁶ each being a methyl, ethyl, isopropyl or n-propyl, isobutyl or n-butyl, pentyl, hexyl, heptyl, octyl, nonyl, decyl, phenyl, benzyl or allyl radical.

The radical R³ is preferably selected from among the preferred radicals of R¹, R⁵, R⁶ and also from among hydrogen, cyclohexyl and phenyl radicals and the radical of the general formula R′″₃₋ₒR⁶ₒSi—R⁷—. The radical R³ is particularly preferably hydrogen.

The radicals R′, R″, R′″ preferably have the meanings of OR¹. Preference is given to R′, R″, R′″ each being, independently of one another, a methoxy, ethoxy, isopropoxy or n-propoxy, butoxy, phenoxy, benzyloxy or allyloxy radical. The radicals R′, R″, R′″ are particularly preferably identical.

Preference is given to the radicals R², R⁴, R⁷ each being a divalent hydrocarbon radical having 1-6 carbon atoms, in particular a methylene, ethylene or propylene group, particularly preferably a methylene or propylene group.

The radical X is preferably chlorine or bromine, in particular chlorine.

m, n, o each preferably have, independently of one another, the value 0, 1 or 2, particularly preferably 0 or 1.

In principle, the steps a) and b) can be carried out in succession or simultaneously. A time-offset mode of operation in which step b), i.e. the addition of the base (B), is started after commencement of but before the end of step a). However, if a base (B) which has free NH or NH₂ groups is used in the process of the invention, step b) for example, the addition of the oligoamine, is preferably carried out after the reaction in step a) is complete. Preference is given to using bases (B) which form salts which form liquids at temperatures of <150° C., particularly preferably <100° C. or <90° C., in process step b).

Step a) of the process of the invention is preferably carried out at temperatures from 50 to 250° C. To achieve a compromise between economically feasible reaction times and a reaction leading to a very low level of by-products, temperatures of 50 to 220° C., in particular from 80° C. to 150° C., have been found to be particularly advantageous. Since step a) is usually exothermic, it is preferably carried out with cooling.

Steps b) and c) of the process of the invention are preferably carried out at temperatures of from 0 to 250° C., preferably at temperatures of from 20 to 150° C., and particularly preferably at temperatures of from 50 to 100° C. The temperature during steps b) and c) preferably remains constant within a temperature range of preferably 30° C., particularly preferably 20° C. Since step b) is usually exothermic, it is preferably carried out with cooling.

All reaction steps are preferably carried out under protective gas, e.g. nitrogen or argon.

In a preferred embodiment of the invention, the process of the invention can also have one or more of the following additional process steps:
a1) If the amine of the general formula (2) has been used in excess in step a), this excess can be completely or partly separated off before the addition of the base (B) in step b). The removal is preferably carried out by distillation. This measure preferably serves to reduce the solubility of the respective salt(s) in the organic phase.
d) Addition of one or more nonpolar solvents (S) to the product-containing phase. The additional solvent(s) can be added before, during or after the process steps a), a1), b) and c). This measure preferably serves to reduce the solubility of the respective salt(s) in the organic phase. If the nonpolar solvent is added after the process step c), salts which precipitate in this step are preferably separated off in an additional separation step, e.g. a filtration. However, the amount of salts to be separated off here are extremely small compared to the original amount of salts in step c) and the separation is correspondingly simple. If the nonpolar solvent is added before or during step c), the respective salts are displaced from the product phase into the liquid phase which consists essentially of the halide of the base (B) and are separated off together with the latter.
e) Separation or purification of the product of the general formula (1) and the (aminoorganyl)silane of the general formula (2) which may have been used in excess in step a) and also been liberated in the salt rearrangement in step b) by distillation. In this fractional distillation, the (aminoorganyl)silane of the general formula (2) is preferably obtained directly in sufficiently high purity for it to be able to be reused without further work-up in the next reaction cycle. The product of the general formula (1) is also preferably obtained directly in sufficient purity in the corresponding distillation.

When at least one radical R′, R″ or optionally R′″ is present in the silylorganoamine of the general formula (1) and R³ is hydrogen and at the same time at least one of the two radicals R² and R⁴ comprises a hydrocarbon chain having at least three carbon atoms, the silylorganoamines tend, especially at elevated temperatures and under reduced pressure, i.e. conditions as occur, for example, during distillation, to undergo an intermolecular or intramolecular displacement of an alkoxy radical by the NH group to form oligomers and rings having Si—N linkage. Particularly the azasilacycles of the general formulae (4a) and (4b)

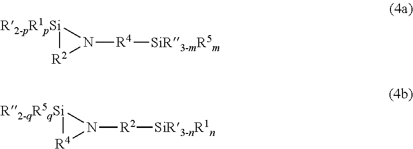

formed from the target product of the general formula (1) can also accumulate in the distillate or even be formed quantitatively. p and q have the meanings 0, 1 or 2. However, addition of the respective alcohol R′—H, R″—H or R′″—H enables the cyclic structure to be opened to give the target product of the general formula (1). Owing to the high reactivity of the Si—N bond, addition of a stoichiometric amount of alcohol relative to the ring is generally sufficient, so that contamination of the silylorganoamine of the general formula (1) by excess alcohol can be avoided. To obtain a target product of the general formula (1) which is free of or low in azasilacycles, it is also possible to add an excess of alcohol to the distilled reaction product and distill off the excess after the reaction is complete under milder conditions than the distillation conditions for the silylorganoamine of the general formula (1), so that recyclization is largely avoided. The ring opening reactions of the azasilacycles formed from the silylorganoamine of the general formula (1) with alcohol generally proceed under mild conditions in a temperature range from 10 to 100° C., preferably from 15 to 50° C.; the optimal reaction conditions can easily be determined in the individual case by means of preliminary tests. When at least one radical R″ is present in the (aminoorganyl)silane of the general formula (2) and if the radical R⁴ comprises a freely mobile chain having at least three atoms, this tends, especially at elevated temperatures and under reduced pressure, i.e. conditions as occur, for example, in the distillation, to undergo an intermolecular or intramolecular displacement of an alkoxy or acyloxy radical by the NH group to form oligomers and rings having Si—N linkage. The azasilacycle of the general formula (5) formed from the (aminoorganyl)silane of the general formula (2), in particular, can accumulate in the distillate or even be formed quantitatively; r has the meaning 0, 1 or 2.

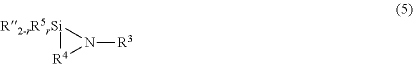

However, addition of the respective alcohol R″—H enables the cyclic structure to be opened again to form the (aminoorganyl)silane of the general formula (2). Owing to the high reactivity of the Si—N bond, addition of a stoichiometric amount relative to the ring of alcohol is generally sufficient, so that contamination of the (aminoorganyl)silane of the general formula (2) by an excess of alcohol can be avoided. To obtain an (aminoorganyl)silane of the general formula (2) which is free of or low in azasilacycles, it is also possible to add an excess of alcohol to the distilled product and distill off the excess after the reaction is complete under milder conditions than the distillation conditions for the (aminoorganyl)silane of the general formula (2), so that recyclization is largely avoided. The ring opening reactions of the azasilacycles formed from the (aminoorganyl)silane of the general formula (2) with alcohol generally proceed under mild conditions in a temperature range from 10 to 100° C., preferably from 15° C. to 50° C.; the optimal reaction conditions can easily be determined in the individual case by means of preliminary tests. If residues of the base (B) remain in the organic phase in the phase separation in step c), these are likewise preferably removed by distillation. The same applies to the solvent (S) which may optionally be additionally added in step d).

It is possible for all components, in particular the product of the general formula (1) (aminoorganyl)silane of the general formula (2) and if appropriate, the base (B) and the solvent (S) to be separated from one another by a single fractional distillation. This can likewise be effected by a plurality of separate distillation steps. Thus, for example, only the (aminoorganyl)silane of the general formula (2) can firstly be removed by distillation, for example, after a preliminary fraction comprising low boilers such as solvent (S) and base (B) has been distilled off, with the crude product initially remaining in the distillation bottoms and subsequently being purified in a separate distillation or thin film evaporator step.
f) Additional addition of ammonia to the product-containing phase after the phase separation in step c) and removal of the ammonium halide formed. This measure can be particularly useful for reducing the halide content in the end product.
g) Addition of additional alkali metal alkoxides, preferably sodium or potassium alkoxides, or alkali metal phosphates, preferably sodium or potassium phosphates or the corresponding hydrogenphosphates or dihydrogenphosphates to the product-containing phase after the phase separation in step c) and removal of the alkali metal halides formed. This measure can be particularly useful for reducing the halide content in the end product.
h) Additional addition of polymeric polyamines to the product-containing phase after the phase separation in step c). This measure can serve to bind any residues of halogen compounds, in particular ionic halides, so that these mostly remain in the distillation bottoms in a final distillation of the product of the general formula (1) (see step e), and a corresponding low-halide product is obtained.
i) Recovery or recycling of any (aminoorganyl)silane of the general formula (2) used in excess in step a) and of the (aminoorganyl)silane of the general formula (2) liberated in step b). If the (aminoorganyl)silane of the general formula (2) cannot be obtained either entirely or at least in part in sufficient purity by means of a simple distillation, cf. step e), the troublesome products, by-products or residues of the base (B) added in step b) can be separated off by means of one or more further purification steps. Mention may be made here by way of example of
   further distillative purification steps of the (aminoorganyl)silane fractions which are not yet sufficiently pure after the first distillation (step e))
   additional addition of aliphatic ketones or aldehydes to the product-containing phase after step c) or to the (aminoorganyl)silane fractions distilled in step e). This measure can, if the base (B) added in step b) is a compound having primary amino groups, serve to convert residues of the base (B) still present in these phases into the corresponding imines. The latter can often be removed more easily from the products and especially from the (aminoorganyl)silanes of the general formula (2) which have been used in excess and/or been liberated again in step b) by distillation than the base (B) itself.
1) Recovery of the base (B) used in step b), preferably by salt rearrangement of the halide of this base, by means of strong bases, e.g. alkali metal or alkaline earth metal hydroxides, carbonates, hydrogencarbonates, etc. Here, the respective bases can be used as such or in aqueous or nonaqueous solution or suspension. If aqueous solutions are used and/or water is liberated in the reaction, this water is preferably separated off from the base (B) by distillation. If ethylenediamine has been used as base (B), this separation by distillation is preferably carried out at a pressure sufficiently high for ethylenediamine and water no longer to form an azeotrope.

If the base (B) is a compound, e.g. an amine, which is itself reactive toward the (haloorganyl)silane of the general formula (3), the (aminoorganyl)silane of the general formula (2) is preferably purified by means of the process steps mentioned to such an extent that the content of the base (B) in the (aminoorganyl)silane of the general formula (2) is less than 3%, preferably less than 1% and in particular less than 0.5%, in each case by weight.

In one variant a solvent (S) whose boiling point is below that of the (aminoorganyl)silane of the general formula (2) but above the boiling point of the base (B), is used in step d), so that any residues of the base (B) present are removed together with the solvent (S) in the organic phase and an (aminoorganyl)silane of the general formula (2) which has the preferred low content of the base (B) can subsequently be obtained by distillation (step e)).

Of course, the process can be carried out either batchwise, e.g. in stirred vessels, or continuously. The latter can, for example, be carried out by carrying out the steps a), b) and any further steps (see above) in a tube reactor or a cascade of stirred vessels. The individual substances are metered in and mixed in together or, preferably, in succession. For the subsequent continuous phase separation (step c)), too, suitable methods, e.g. using calming or settling vessels, decanters, etc., are known and widely described in the literature.

In a preferred embodiment, compounds whose boiling point differs both from the product of the general formula (1), its cyclization products, azasilacycles of the general formula (4a) or (4b) and from the (aminoorganyl)silane of the general formula (2) by at least 40° C., preferably by at least 60° C. and particularly preferably at least 90° C., so that residues of the base (B) which remain in the organic phase in the phase separation in step c) can be separated off sufficiently readily both from the product of the general formula (1) or (4a) or (4b) and from the (aminoorganyl)silane of the general formula (2) by distillation.

As base (B), preference is given to using oligoamines (O) containing ethylenediamine or propylenediamine units. The oligoamines (O) preferably contain from 1 to 20, in particular from 1 to 10, ethylenediamine or propylenediamine units.

Preferred oligoamines (O) are ethylenediamine, diethylenetriamine, diazabicyclooctane, pentamethyl-diethylenetriamine, propylenediamine, N,N′-bis(3-aminopropyl)ethylenediamine.

Particular preference is given to using ethylenediamine as base (B).

Thus, ethylenediamine displays the following surprising property combination in the process of the invention:
The addition of ethylenediamine in step b) leads to largely complete salt rearrangement even when only the particularly preferred ethylenediamine amount of from 0.8 to 2 equivalents based on the amount of the (haloorganyl)silane of the general formula (3) is added.
The salt phase obtained by means of the substantial salt rearrangement has a melting point of about 80° C.
The liquid salt phase separates completely from the organic phase after only a few minutes and can thus be separated off without a long and thus costly time requirement for phase separation.

Particularly in the presence of hydrolyzable radicals R′, R″, and optionally R′″ in the reactants, the presence of water can possibly lead to undesirable secondary reactions (hydrolysis, condensation), which reduce the yield of product of the general formula (1). The water content of the individual components, in particular the bases (B) to be used and any solvent (S) to be used, is therefore preferably from 0 to 20 000 ppm, more preferably from 0 to 5000 ppm, particularly preferably from 0 to 2000 ppm, in each case by weight.

The process of the invention enables silylorganoamines of the general formula (1) to be obtained in good to very good yields in a simple way. The processes can be implemented simply and safely in industry.

For example, the following silylorganoamines of the general formula (1) can be obtained according to the invention:
(MeO)₃Si—CH₂CH₂CH₂—NH—CH₂CH₂CH₂—Si(OMe)₃
(MeO)₃Si—CH₂CH₂CH₂—N (cyHexyl)-CH₂CH₂CH₂—Si(OMe)₃
(MeO)₃Si—CH₂CH₂CH₂—NH—CH₂CH₂—NH—CH₂CH₂CH₂—Si (OMe)₃
(MeO)₃Si—CH₂—NH—CH₂CH₂—NH—CH₂CH₂CH₂—Si (OMe)₃
(MeO)₃Si—CH₂—NH—CH₂CH₂—NH—CH₂—Si (OMe)₃
(EtO)₃Si—CH₂CH₂CH₂—NH—CH₂CH₂CH₂—Si (OEt)₃
(MeO)₃Si—CH₂—NH—CH₂CH₂CH₂—Si (OMe)₃
(EtO)₂MeSi—CH₂—NH—CH₂CH₂CH₂—SiMe(OEt)₂
(MeO)₂MeSi—CH₂—NPh-CH₂CH₂CH₂—Si (OMe)₃
((MeO)₃Si—CH₂—)₂N—CH₂CH₂CH₂—SiMe(OMe)₂
(MeO)₃Si—CH₂N—(CH₂CH₂CH₂—Si(OMe)₃)₂
(Me₃Si—CH₂—)₃N
((iPrO)₃Si—CH₂)₃N
(Me₃Si—CH₂—)((MeO)₃Si—CH₂—)N—CH₂CH₂CH₂—Si (OMe)₃
(Me₃Si—CH₂—)₂N—CH₂—Si(OEt)₃

In the process of the invention, different alkoxy radicals can be introduced into one molecule (for example methoxy and ethoxy radicals). In this case, it has to be expected that alkoxy group exchange will take place during the production process or during storage of the end product of the general formula (1) so as to form mixtures, which can indeed be desirable.

The purity of the bis- and tris(silylorgano)amines of the general formula (1), including the azasilacycles of the general formulae (4a) and (4b) which may possibly be formed in the synthesis or distillation of the target product is preferably at least 85%, particularly preferably at least 95%. The purity can be increased to above 95% by means of an optional subsequent distillation step e) for the product.

Compared to the prior art, the process of the invention offers the advantage that the major part of the ammonium salts of the (aminoorganyl)silanes of the general formula (2) formed as by-product does not have to be separated off as solid, which on an industrial scale is usually complicated and expensive, especially in the case of ammonium salts which do not crystallize well. In addition, many multipurpose plants do not have sufficiently high-performance plant elements (e.g. centrifuges) for separating off such large amounts of solid. As a result of the salt rearrangement, two liquid phases can be separated from one another in a simple way. In addition, steps for washing the filter cake with additional solvent become unnecessary. At the same time, the formation of by-products can be significantly reduced by use of optimized excesses of (aminoorganyl)silane of the general formula (2). It is also noteworthy that the process of the invention is suitable for recovering the expensive (aminoorganyl) silanes of the general formula (2) which are consumed in step a) for forming the corresponding ammonium salts by means of the salt rearrangement with the generally relatively inexpensive base (B), e.g. ethylenediamine, and thereby making them available for further use.

All symbols in the above formulae have their meanings independently of one another in each case. In all formulae, the silicon atom is tetravalent.

Unless indicated otherwise, all amounts and percentages in the following examples are by weight and all pressures are 0.10 MPa (abs).

### EXAMPLES

### Example 1

### Preparation of bis(3-(trimethoxysilyl)propyl)amine

In a 4 l four-neck flask provided with reflux condenser, precision glass stirrer and thermometer, 2300 g of 3-aminopropyltrimethoxysilane (commercially available from Wacker Chemie AG under the trade name Geniosil® GF 96) were heated to 130° C. and 864 g of 3-chloropropyltrimethoxysilane (commercially available from Wacker Chemie AG under the trade name Geniosil® GF 16) were added over a period of 120 minutes while stirring. After the addition was complete, the mixture was stirred for a further four hours at 130° C. The temperature was subsequently reduced to 110° C. and 392 g of ethylenediamine were added to the mixture over a period of 10 minutes while stirring, with phase separation occurring. At the same temperature, the mixture was stirred for another 60 minutes and the heavier ethylenediamine hydrochloride phase was then separated off. The upper phase was fractionally distilled via a 30 cm Vigreux column. This gave 1200 g of a mixture which, according to gas chromatography, contained 77.4% of bis(3-)trimethoxysilyl)propyl)amine and also 22% of the cyclization product (=1,1-dimethoxy-1-sila-2-(3-(trimethoxysilyl)propyl) azacyclopentane). After addition of 27.5 g of methanol, the mixture was stirred at 20° C. for 30 minutes. This gave 1227 g of bis(3-(trimethoxysilyl)propyl)amine having a purity determined by gas chromatography of 98.4% (yield: 81% of theory). The total chlorine content was 8 ppm by weight.

### Example 2

### Preparation of bis(3-(trimethoxysilyl)propyl)tri-methoxysilylmethylamine

In a 500 ml four-neck flask provided with reflux condenser, precision glass stirrer and thermometer, 350 g of bis(3-(trimethoxysilyl)propyl)amine (product from example 1) were heated to 120° C. and 70 g of chloromethyltrimethoxysilane were added over a period of 90 minutes while stirring. After the addition was complete, the temperature was reduced to 105° C. and 30 g of ethylenediamine were added to the mixture over a period of 5 minutes while stirring, with phase separation occurring. At the same temperature, the mixture was stirred for another 30 minutes and the heavier ethylenediamine hydrochloride phase was then separated off. The upper phase was distilled in a two-stage thin film evaporator. This gave 198 g (94% recovery) of bis(3-)trimethoxysilyl)propyl)amine having a purity of 93% and 169 g (yield: 95%) of bis(3-(trimethoxysilyl)propyl) trimethoxysilylmethylamine having a purity determined by means of gas chromatography of 95.4%.

### Example 3

### Preparation of bis((trimethylsilyl)methyl)triethoxy-silylmethylamine

In a 250 ml four-neck flask provided with reflux condenser, precision glass stirrer and thermometer, 40 g of bis((trimethylsilyl)methyl)amine*) were heated to 140° C. and 21 g of chloromethyltriethoxysilane were added over a period of 30 minutes while stirring and the mixture was stirred for another 60 minutes. The temperature was then reduced to 100° C. and 20 g of ethylenediamine were added to the mixture over a period of 3 minutes while stirring, with phase separation occurring. At the same temperature, the mixture was stirred for another 20 minutes while being cooled to 50° C. and the heavier ethylenediamine hydrochloride phase was then separated off. The upper phase was fractionally distilled without a distillation column. This gave 19.8 g of bis((trimethylsilyl)methyl)amine having a purity of 97.2% (95% recovery) and 23.2 g (yield: 85%) of bis((trimethylsilyl)methyl)triethoxy-silylmethylamine whose purity was found to be 97.5%. The chloride value of the product was 88 ppm by weight.*) Obtainable by the method of: George, P. D.; Elliott, J. R, General Elec. Co., Schenectady, N.Y., Journal of the American Chemical Society (1955), 77, 3493-8.

### Example 4

### Preparation of phenyl(3-trimethoxysilylpropyl) (dimethoxy)methylsilylmethylamine

In a 1000 ml four-neck flask provided with reflux condenser, precision glass stirrer and thermometer, 455 g of N-phenyl(dimethoxy)methylsilylmethylamine were heated to 120° C. and 169 g of 3-chloropropyl-trimethoxysilane were added over a period of 60 minutes while stirring. The mixture was stirred for another 60 minutes. The temperature was then reduced to 105° C. and 90 g of ethylenediamine and 50 g of o-xylene were added to the mixture over a period of 10 minutes while stirring, with phase separation occurring. At the same temperature, the mixture was stirred for another 30 minutes while being cooled to 70° C. and the heavier ethylenediamine hydrochloride phase was then separated off. The upper phase was admixed with 6 g of a polyethylenimine having a viscosity of 5 Pas at 20° C. (Lupasol® G20 anhydrous (BASF AG)) and, after taking off the low boilers (predominantly o-xylene, reduced pressure to 100° C./10 mbar), was distilled under reduced pressure in a two-stage thin film evaporator. 223 g of N-phenyl(dimethoxy)methylsilylmethylamine

(91% recovery) having a purity of 95.8% were obtained in the first stage. In the second stage, 312 g of phenyl(3-trimethoxysilylpropyl)trimethoxysilylmethylamine distilled over (91% yield). The chloride value was <3 ppm by weight.

1. A process for preparing silylorganoamines of the general formula (1)
R′₃₋ₙR¹ₙSi—R²—NR³—R⁴—SiR″₃₋ₘR⁵ₘ (1)
by reacting (aminoorganyl)silanes of the general formula (2),
H—NR³—R⁴—SiR″₃₋ₘR⁵ₘ (2)
with (haloorganyl)silanes of the general formula (3)
R′₃₋ₙR¹ₙSi—R²—X (3),
where
R′, R″ are each an alkoxy radical having 1-10 carbon atoms,
R¹, R⁵ are each a hydrocarbon radical having 1-10 carbon atoms,
R² is a divalent hydrocarbon radical which has 1-10 carbon atoms and in which the hydrocarbon chain can be interrupted by carbonyl groups, carboxyl groups, oxygen atoms or sulfur atoms,
R⁴ is a divalent hydrocarbon radical which has 1-10 carbon atoms and in which the hydrocarbon chain can be interrupted by carbonyl groups, carboxyl groups, oxygen atoms, sulfur atoms, NH or NR⁸ groups, where R⁸ has the same meanings as R¹, R⁵,
R³ is hydrogen, a hydrocarbon radical having 1-10 carbon atoms or a radical of the general formula R′″₃₋ₒR⁶ₒSi—R⁷—, where
R⁶ has the same meanings as R¹ and R⁵,
R⁷ has the same meanings as R² and R⁴, and
R′″ has the same meanings as R′ and R″,
m, n, o are each, independently of one another, 0, 1, 2 or 3, and
X is chlorine, bromine or iodine,
wherein the reaction comprises the following steps:
a) reaction of the (haloorganyl)silane of the general formula (3) and the (aminoorganyl)silane of the general formula (2) at a temperature of from 0 to 250° C., forming not only the silylorganoamine of the general formula (1) but also the ammonium halide of the (aminoorganyl)silane of the general formula (2) as by-product,
b) addition of a base (B), resulting in a complete or partial salt rearrangement in which the (aminoorganyl)silane of the general formula (2) is liberated again and the halide of the base (B) is formed, where the halide of the base (B) is liquid at temperatures of not more than 200° C., and
c) removal of the resulting liquid halide of the base (B).

2. The process as claimed in claim 1, wherein the (aminoorganyl)silane of the general formula (2) is used in a molar ratio to (haloorganyl)silane of the general formula (3) of from 1.5:1 to 50:1.

3. The process as claimed in claim 1, wherein the base (B) is used in a molar ratio to silane of the general formula (3) of from 0.7:1 to 10:1.

4. The process as claimed in claim 1, wherein X is chlorine.

5. The process as claimed in claim 1, wherein a base (B) which forms hydrohalides which form liquids at temperatures of <200° C. in process step b) is used.

6. The process as claimed in claim 1, wherein oligoamines (O) having from 1 to 20 ethylenediamine or propylenediamine units are used as base (B).

7. The process as claimed in claim 1, wherein ethylenediamine is used as base (B).

8. The process as claimed in claim 2, wherein the base (B) is used in a molar ratio to silane of the general formula (3) of from 0.7:1 to 10:1.

9. The process as claimed in claim 8, wherein X is chlorine.

10. The process as claimed in claim 9, wherein a base (B) which forms hydrohalides which form liquids at temperatures of <200° C. in process step b) is used.

11. The process as claimed in claim 10, wherein oligoamines (O) having from 1 to 20 ethylenediamine or propylenediamine units are used as base (B).

12. The process as claimed in claim 11, wherein ethylenediamine is used as base (B).
